(19) United States
(12) Patent Application Publication
(10) Pub. No.: US 2017/0346919 A1
(43) Pub. Date: Nov. 30, 2017

(54) BLUETOOTH DEVICE AND BLUETOOTH DEVICE NAME MANAGING METHOD

(71) Applicant: UBTECH Robotics Corp., Shenzhen (CN)

(72) Inventors: WEI HE, Shenzhen (CN); Youjun Xiong, Shenzhen (CN)

(21) Appl. No.: 15/289,972

(22) Filed: Oct. 11, 2016

(30) Foreign Application Priority Data
May 27, 2016 (CN) 201610370025.X

(51) Int. Cl. H04L 29/08; H04W 4/00; H04L 29/12

(52) U.S. Cl. CPC H04L 67/303; H04L 61/6022; H04W 4/008

(57) ABSTRACT

A BLUETOOTH device name managing method is performed fey a BLUETOOTH device. A unique ID is generated according to a physical address of the BLUETOOTH device. An original BLUETOOTH device name of the device is obtained. A combined BLUETOOTH device name is formed by combining the unique ID and the original BLUETOOTH device name. And the original BLUETOOTH device name is replaced with the combined BLUETOOTH device name.

### CROSS REFERENCE TO RELATED APPLICATIONS

This application claims priority to Chinese Patent Application No. 201610370025.X, filed May 27, 2016, which is hereby Incorporated by reference herein as if set forth in its entirety.

### BACKGROUND

### 1. Technical Field

The present disclosure generally relates to BLUETOOTH technology, and particularly to a BLUETOOTH device and a BLUETOOTH device name managing method.

2. Description of Related Art

BLUETOOTH is a standard of wireless connection between electronic-devices for short-range wireless communication at a low cost. Referring to FIG. 1, a BLUETOOTH communication system includes a master device 2, such as a smart phone or other portable devices, and a slave device 1, such as a robot.

When the master device 2 only pairs with one slave device 1 via BLUETOOTH, the slave device 1 can be easily recognized, and then information can be transferred between the master device 2 and the slave device 1. However, when the master device 2 pairs with a plurality of electronic devices via BLUETOOTH, which are the same type and have the same BLUETOOTH device names, it is difficult to recognize which device is needed to transfer information.

The master device 2 operated in Android system can read physical addresses via the BLUETOOTH, and the electronic devices can be recognized by different physical addresses thereof. However, it is not a direct recognition to different electronic devices. The master device 2 operated in iOS cannot read a physical address via the BLUETOOTH at all, thus the electronic devices cannot be easily recognized.

Therefore, a need exists in the industry to overcome the described problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a diagrammatic drawing of a BLUETOOTH communication system having a master device and a slave device.

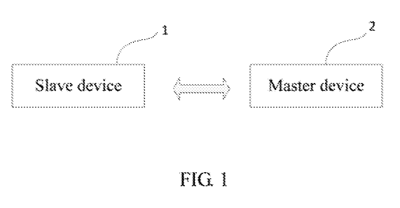

FIG. 2 is a diagrammatic drawing of the slave device of FIG. 1.

FIG. 3 is a flowchart of a BLUETOOTH device name managing method according to one embodiment.

FIG. 4 is a diagrammatic drawing of a BLUETOOTH device name managing system according to one embodiment.

### DETAILED DESCRIPTION

The disclosure is Illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

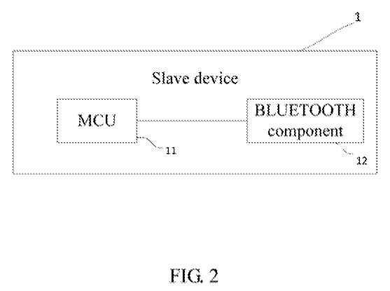

Referring to FIG. 2, the slave device 1 can include a Micro Controller Unit (MCU) 11 and a BLUETOOTH component 12. The stave device 1 is controlled by the MCU 11. The BLUETOOTH component 12 is used for wireless communication with the master device 2. In the embodiment, the master device 2 and the slave device 1 are both BLUETOOTH devices having BLUETOOTH components. In general, the BLUETOOTH component 12 has a BLUETOOTH device name and a unique physical address, such as MAC address. The BLUETOOTH device name and the physical address are stored in a storage of the BLUETOOTH component 12. The MCU 11 can read the BLUETOOTH device name and the physical address. When, the master device 2 pairs with the BLUETOOTH component 12 of the slave device 1, the information can be transferred between a BLUETOOTH module of the master device 2 and the BLUETOOTH component 12 of the slave device 1. The BLUETOOTH device name can be displayed in a display of the master device 2. The slave device 1 can send a feedback signal or perform a certain action according to a command sent by the master device 2 via the BLUETOOTH module.

Slave devices 1 manufactured by the same manufacturer may have the same BLUETOOTH device name, thus the plurality of slave devices 1 are difficult to be recognized by the master device 2.

In the embodiment, the slave device 1 can be a robot, the master device 2 can he a smart phone, a pad or other similar portable devices. An original BLUETOOTH device name that is given by the manufacturer is stored in the storage of the BLUETOOTH component 12.

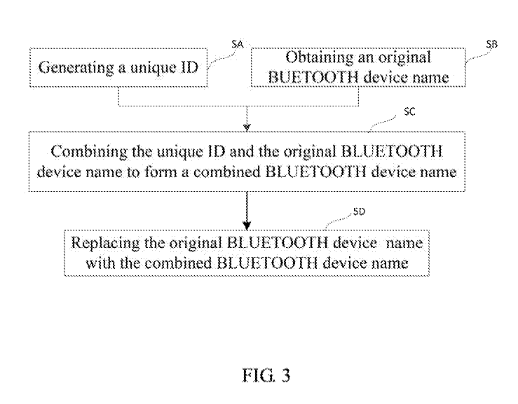

FIG. 3 shows a flowchart of one embodiment of a BLUETOOTH device name managing method. Depending on the embodiment, additional steps may be added, others removed, and the ordering of the steps may be changed.

In step SA: obtaining the physical address of the BLUETOOTH component 12 and generating a unique ID according to the physical address. In detail, the MCU 11 reads the physical address stored in the storage of the BLUETOOTH component 12 and generates the unique ID according to the physical address. The unique ID is denoted by “X”.

In step SB: obtaining the original BLUETOOTH device name of the BLUETOOTH component 12. In detail, the MCU 11 reads the original BLUETOOTH device name stored in the storage of the BLUETOOTH component 12. In the embodiment, the original BLUETOOTH device name of the BLUETOOTH component 12 is JIMU.

In step SC: combining the unique ID with the original BLUETOOTH device name to form a combined BLUETOOTH device name. In the embodiment, the unique ID is served as a prefix or a suffix of the original BLUETOOTH device name. If the unique ID is served as the suffix of the original BLUETOOTH device name, the combined BLUETOOTH device name is JIMUX.

In step SD: replacing the original BLUETOOTH device name with the combined BLUETOOTH device name. In detail the combined BLUETOOTH device name is stored in the storage of the BLUETOOTH component 12 and the original BLUETOOTH device name is covered by the combined BLUETOOTH device name. In the embodiment, the combined BLUETOOTH device name JIMUX is stored in the storage of the BLUETOOTH component 12.

In the embodiment, the physical address can be Media Access Control (MAC) address. Each BLUETOOTH device includes a globally unique identifier, such as physical, address. The unique ID can be directly generated on basis of the physical address. In another embodiment, the unique ID can be generated via compiling the physical address. The combined BLUETOOTH device name is unique since the unique ID is unique.

In the embodiment, the unique ID can include a plurality of numbers, letters, or other symbols. The number of the unique ID is not limited, for example the unique ID includes four to eight bits. In another embodiment, the unique ID can include more bits to ensure uniqueness.

In the embodiment, last four bits of physical address is served as the unique ID. The original BLUETOOTH device name is JIMU, and the MAC address of the BLUETOOTH component 12 is 44-45-53-54-00-00, thus the original BLUETOOTH device name JIMU is replaced with JIMU0000.

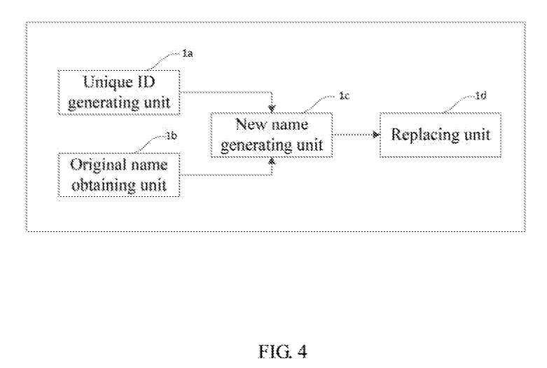

FIG. 4 shows a diagrammatic drawing of a BLUETOOTH device name managing system according to one embodiment. The BLUETOOTH device name managing system may include a plurality of programs in the form of one or more computerized instructions executed by the MCU 11 to perform operations of the slave device 1. In the embodiment, the BLUETOOTH device name managing system includes a unique ID generating unit 1a, an original name obtaining unit 1b, a new name generating unit 1c, and replacement unit 1d. In general, the word “unit”, as used herein, refers to logic embodied in hardware or firmware, or to a collection of software instructions, written in a programming language, such as Java, C, or assembly. One or more software Instructions in the unite may be embedded in firmware, such as in an erasable programmable read only memory (EPROM). The units described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

The unique ID generating unit 1a obtains a physical address and generates the unique ID according to the physical address. In the embodiment, the physical address can be Media Access Control (MAC) address. Each BLUETOOTH device includes a globally unique identifier, such as physical address. The unique ID can be directly generated on basis of the physical address. In another embodiment, the unique ID can be generated via compiling the physical address. The unique ID has unique attribute, thus the combined BLUETOOTH device name is unique because of the unique ID. In the embodiment, the unique ID can include a plurality of numbers, letters, or other symbols. The number of the unique ID is not limited, for example the unique ID includes four to eight bits. In another embodiment, the unique ID can include more bits to ensure uniqueness.

The original name obtaining unit 1b obtains the original BLUETOOTH device name. The original BLUETOOTH device name is stored in the storage of the MCU 11.

The new name generating unit 1c combines the unique ID with the original BLUETOOTH device name to form the combined BLUETOOTH device name. In the embodiment, last four bits of physical address is served as the unique ID. The original BLUETOOTH device name is JIMU, and the MAC address of the BLUETOOTH component 12 is 44-45-53-54-00-00, thus the combined BLUETOOTH device name is JIMU0000.

The replacement, unit 1d replaces the original BLUETOOTH device name with the combined BLUETOOTH device name. In the embodiment, the original BLUETOOTH device name JIMU is replaced with the combined BLUETOOTH device name JIMU0000.

When the master device 2 pairs with the slave device 1, the combined BLUETOOTH device name is displayed in the display of the master device 2. It is easy to recognize which slave device 1 is needed to transfer information.

The BLUETOOTH device name managing system and method can directly read the physical address of the BLUETOOTH component 12, thus the unique ID generating unit 1a can automatically generate the unique ID according to the physical address. And then the unique ID is combined with the original BLUETOOTH device name to form the combined BLUETOOTH device name. The original BLUETOOTH device name is replaced with the combined BLUETOOTH device name. The BLUETOOTH device name is managed in the slave device 1 without the master device 2, thus the BLUETOOTH device name managing method is much easier and more convenient.

Although the features and elements of the present disclosure are described as embodiments in particular combinations, each feature or element can be used alone or in other various combinations within the principles of the present disclosure to the fall extent indicated by the broad general meaning of the terms in which the appended claims are expressed.

What is claimed is:

1. A BLUETOOTH device, comprising:
a micro control unit (MCU);
a storage; and
one or more programs stored in the storage and executed by the MCU, the one or more programs comprising:
a unique ID generating unit generating a unique ID according to a physical address of the BLUETOOTH device;
an original name obtaining unit obtaining an original BLUETOOTH device name of the BLUETOOTH device;
a new name generating unit combining the unique ID with original BLUETOOTH device name to form a combined BLUETOOTH device name; and
a replacement unit replacing the original BLUETOOTH device name with the combined BLUETOOTH device name.

2. The BLUETOOTH device of claim 1, wherein the unique ID generating unit directly obtains the physical address.

3. The BLUETOOTH device of claim 1, wherein the physical address and the original BLUETOOTH device name are stored in the storage.

4. The BLUETOOTH device of claim 1, wherein the unique ID comprises a plurality of numbers, letters, or symbols.

5. The BLUETOOTH device of claim 4, wherein the unique ID comprises four to eight bits.

6. The BLUETOOTH device of claim 5, wherein the unique ID is last four bits of the physical address.

7. The BLUETOOTH device of claim 1, wherein the physical address is MAC address.

8. A BLUETOOTH device name managing method, comprising:
generating a unique ID according to a physical address of a BLUETOOTH device;
obtaining an original BLUETOOTH device name of the BLUETOOTH device;
combining the unique ID with the original BLUETOOTH device name to form a combined BLUETOOTH device name; and
replacing the original name with the combined BLUETOOTH device name.

9. The BLUETOOTH device name managing method of claim 8, further comprising: directly obtaining the physical address.

10. The BLUETOOTH device name managing method of claim 8, wherein the physical address and the original BLUETOOTH device name are stored in a storage of the BLUETOOTH device.

11. The BLUETOOTH device name managing method of claim 8, wherein the unique ID comprises a plurality of numbers, letters, or symbols.

12. The BLUETOOTH device name managing method of claim 11, wherein the unique ID comprises four to eight bits.

13. The BLUETOOTH device name managing method of claim 12, wherein the unique ID is last four bits of the physical address.

14. The BLUETOOTH device name managing method of claim 8, wherein the physical address is MAC address.

15. A non-transitory computer readable storage medium storing instructions that, when executed by a micro controller unit (MCU), cause the MCU to implement a BLUETOOTH device name managing method wherein the BLUETOOTH desire name managing method comprises:
generating a unique ID according to a physical address of a BLUETOOTH device;
obtaining an original BLUETOOTH device name of the BLUETOOTH device;
combining the unique ID with the original BLUETOOTH device name to form a combined BLUETOOTH device name; and
replacing the original BLUETOOTH device name with the combined BLUETOOTH device name.

16. The non-transitory computer readable storage medium of claim 15, wherein the BLUETOOTH device name managing method further comprises: directly obtaining the physical address.

17. The non-transitory computer readable storage medium of claim 15, wherein the physical address and the original BLUETOOTH device name are stored in a storage of the BLUETOOTH device.

18. The non-transitory computer readable storage medium of claim 15, wherein the unique ID comprises a plurality of numbers, letters, or symbols.

19. The non-transitory computer readable storage medium of claim 15, wherein the unique ID comprises four to eight bits.

20. The non-transitory computer readable storage medium of claim 19, wherein the unique ID is last four bits of the physical address.
